(19) United States
(12) Patent Application Publication
(10) Pub. No.: US 2015/0200468 A1
(43) Pub. Date: Jul. 16, 2015

(54) MULTI-WIRE RECEIVING ELECTRICAL CONNECTOR ASSEMBLY

(71) Applicant: Caterpillar Inc., Peoria, IL (US)

(72) Inventor: Donald P. Froelich, Abingdon, IL (US)

(73) Assignee: Caterpillar Inc., Peoria, IL (US)

(21) Appl. No.: 14/669,029

(22) Filed: Mar. 26, 2015

(51) Int. Cl. H01R 4/38

(52) U.S. Cl. CPC H01R 4/38

(57) ABSTRACT

A multi-wire receiving electrical connector assembly includes a unitary main body unit configured to receive multiple electrical wires. The unitary main body unit includes at least two cable receiving ports configured to receive one of the multiple electrical wires therein and providing an independent electrical connection thereof. The unitary main body unit also includes at least two clamping members configured to attach the one of the multiple electrical wires within the respective cable receiving port. The unitary main body unit further includes at least two screw elements in communication with the respective clamping member to affix the one of the multiple electrical wires within the respective cable receiving port. The multi-wire receiving electrical connector assembly further includes a male plug portion electrically connected to each of the at least two cable receiving ports, and configured to be removably connected to a female jack portion.

### TECHNICAL FIELD

The present disclosure relates to non-permanent wire end connectors for quick connect and disconnect, and more particularly towards a banana plug assembly for accommodating multiple electrical wires.

### BACKGROUND

Wire end connectors that provide a construct for quick connect and disconnect are often termed “banana plugs” and these banana plugs are electrical connectors used for joining wires to equipment. Banana plugs are frequently used to terminate patch cords for electronic test equipment. For example, banana plugs may be used on cables for connecting an amplifier to a loudspeaker in a sound system. Conventional banana plugs are provided with a pin configured to be removably connected to the equipment, a terminal to which an electrical cable is either screwed, soldered, or crimped, a plastic enclosure to achieve insulation, and may also be provided with a female jack portion so as to receive another banana plug.

The electrical wires as connected to the banana plug receive audio, electrical, or the like signals through the equipment to which the banana plug is connected. However, such banana plugs provide connection to only a single electrical wire. As need arises to connect multiple electrical wires to the equipment, multiple banana plugs are stacked to each other to achieve multiple terminals to which multiple wires can be connected. However, such an arrangement is inefficient as it is prone to disassembling during operation due to cantilevered effect of multiple banana plugs. Further, stacking up of multiple banana plugs does not ensure an independent electrical connection as the signals may experience distortion while being transmitted from the equipment and received by the stacked banana plugs. Further, stacking up of banana plugs also increases cost of the system.

U.S. Pat. No. 7,914,342 relates to a kind of signal plug, mainly comprising of a body and a sleeve. On the front of the body there is a C-shaped section contact pin and on the end, there is a positioning device and conducting wire anchor parts. The sleeve has a hole passing through it, a positioning part and joining screw guide hole. These components combined make plug assembly convenient and make wiring connecting easier and safer, and, moreover, increase the signal conductivity of the main body because the contact pin to the conducting wire anchor parts is a one piece design. However, the disclosed signal plug is configured to receive only two electrical wires, and would not serve the purpose if more than two electrical cables are to be connected to any electrical equipment through the signal plug.

### SUMMARY OF THE DISCLOSURE

In one aspect of the present disclosure, a multi-wire receiving electrical connector assembly is disclosed. The multi-wire receiving electrical connector assembly includes a unitary main body unit configured to receive multiple electrical wires. The unitary main body unit includes at least two cable receiving ports positioned in a side by side relationship with respect to each other. The at least two cable receiving ports are provided on a first surface of the unitary main body unit, wherein each of the at least two cable receiving ports are partitioned from each other by a wall therebetween. Further, each of the at least two cable receiving ports are configured to receive one of the multiple electrical wires therein whereby independent electrical connection for each electrical wire is provided thereof. The unitary main body unit also includes at least two clamping members. Each of the at least two clamping members are associated with the respective cable receiving port. The at least two clamping members are configured to attach the one of the multiple electrical wires within the respective cable receiving port. The unitary main body unit further includes at least two screw elements positioned in a side by side relationship with respect to each other. The at least two screw elements are provided on a second surface of the unitary main body unit, the second surface of the unitary main body unit being adjacent to the first surface. Each of the at least two screw elements are in communication with the respective clamping member, and each of the at least two screw elements are configured to affix the one of the multiple electrical wires within the respective cable receiving port. The multi-wire receiving electrical connector assembly further includes a male plug portion extending from one end of the unitary main body unit. The male plug portion being electrically connected to each of the at least two cable receiving ports in a parallel configuration, wherein the male plug portion is configured to be removably connected to a female jack portion.

Other features and aspects of this disclosure will be apparent from the following description and the accompanying drawings.

### BRIEF DESCRIPTION OF THE DRAWINGS

FIG. 1 is a perspective view of an exemplary multi-wire receiving electrical connector assembly having a plane A-A′, according to one embodiment of the present disclosure;

FIG. 2 is a top view of the multi-wire receiving electrical connector assembly of FIG. 1, according to one embodiment of the present disclosure;

FIG. 3 is a cross sectional view of the multi-wire receiving electrical connector assembly along the plane A-A′ of FIG. 1, according to one embodiment of the present disclosure; and

FIG. 4 is a perspective view of the multi-wire receiving electrical connector assembly of FIG. 1 attached to an equipment, according to one embodiment of the present disclosure.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

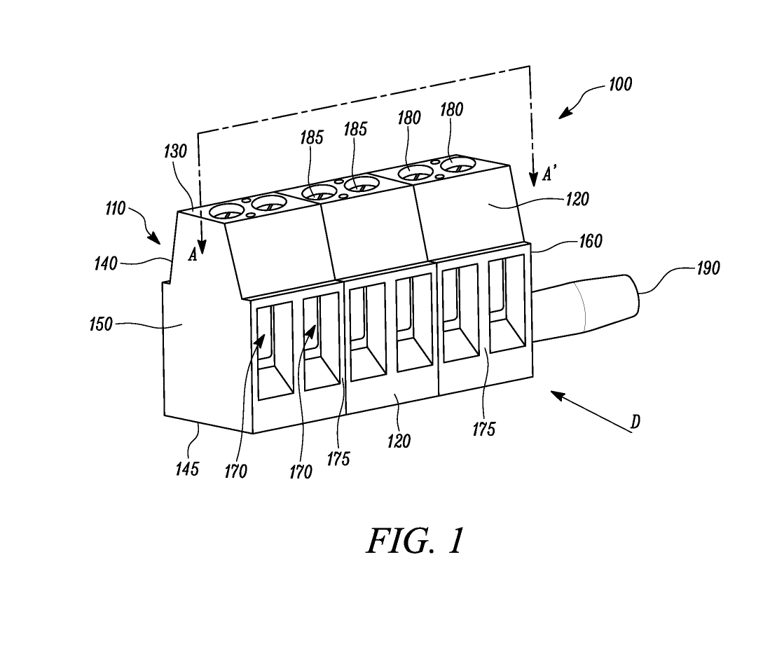

FIG. 1 is a perspective view of an exemplary multi-wire receiving electrical connector assembly 100, hereinafter referred to as a connector plug assembly 100 in context of the present disclosure. The connector plug assembly 100 includes a unitary main body unit 110. The unitary main body unit 110 is made up of an insulating material, such as, plastic, ceramic, fiber glass, or the like. The unitary main body unit 110 includes a first surface 120, a second surface 130, a third surface 140, a fourth surface 145, a back surface 150, and a front surface 160. The first surface 120 is a side surface of the unitary main body unit 110 and the second surface 130 is a top surface of the unitary main body unit 110.

The unitary main body unit 110 further includes at least two cable receiving ports 170, of which six cable receiving ports 170 are illustrated in the accompanying drawings. In an embodiment, as shown in FIG. 1, the cable receiving ports 170 are disposed on the first surface 120 in a side by side relationship with respect to each other. The cable receiving ports 170 are positioned along a length of the unitary main body unit 110 between the back surface 150 and the front surface 160. Each of the cable receiving ports 170 are insulated from each other through intermediate walls 175.

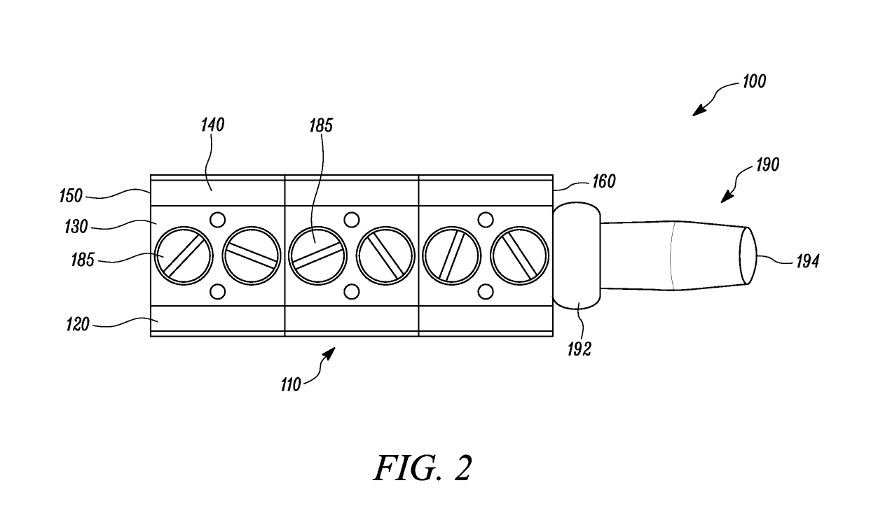

Six recesses 180 are provided on the second surface 130 of the unitary main body unit 110. In an embodiment, the recesses 180 are provided in a side by side relationship with respect to each other. The recesses 180 are positioned along the length of the unitary main body unit 110 between the back surface 150 and the front surface 160. The recesses 180 are in association with the cable receiving ports 170. The recesses 180 are configured to receive screw elements 185 therein. Referring to FIG. 2, screw elements 185 are disposed on the second surface 130. The connector plug assembly 100 further includes the male plug portion 190 extending from the front surface 160. The male plug portion 190 includes a base 192 and a top 194.

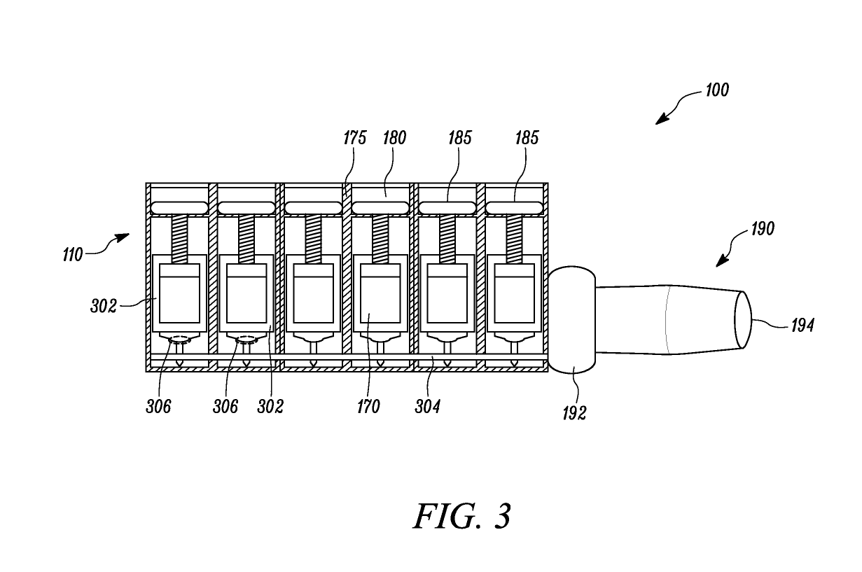

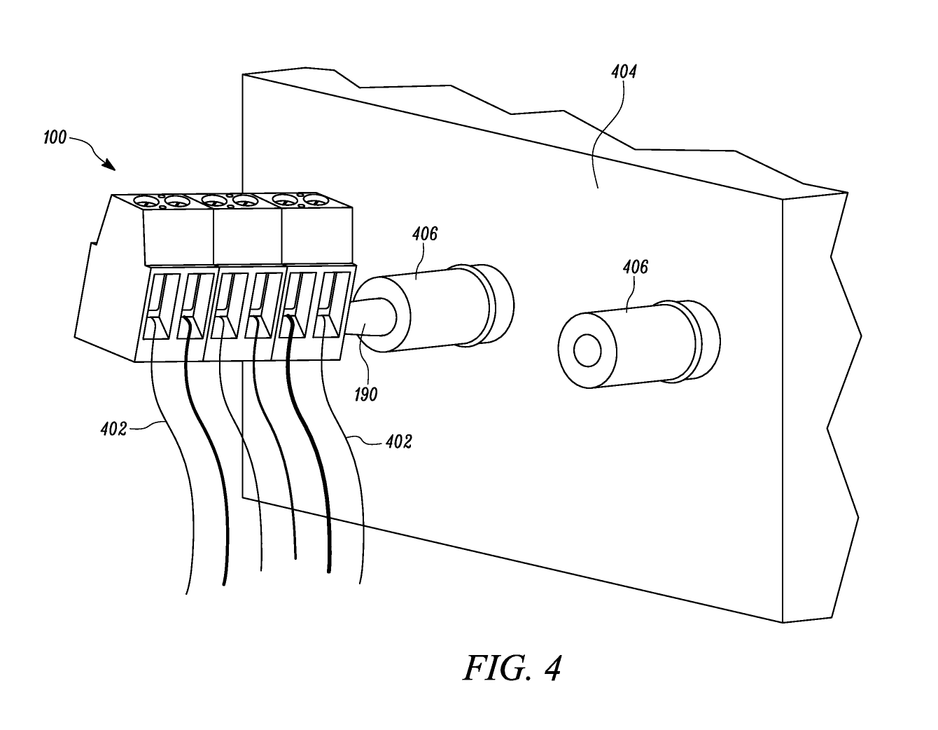

FIG. 3 illustrates a cross sectional view of the connector plug assembly 100 about the plane A-A′ of FIG. 1 as seen along a direction D. Each of the cable receiving ports 170 includes a clamping member 302. In the accompanying drawings, six clamping members 302 are in fastening communication with the six screw elements 185 i.e., the clamping members 302 are configured to fasten or unfasten through the screw elements 185. The unfastening or fastening of the clamping members 302 with the corresponding screw element 185 would result in movement of the clamping members 302. Further in an embodiment, the connector plug assembly 100 is configured to receive multiple electrical wires 402 (see FIG. 4) within each of the cable receiving ports 170. Based on a tightening of each of the screw elements 185, the electrical wires 402 may be securely held within the respective cable receiving port 170. A sizing of each of the cable receiving ports 170 may vary in order to accommodate corresponding sizing of the electrical wire 402.

The connector plug assembly 100 further includes an electrical conductor 304 extending from the base 192 of the male plug portion 190 into the unitary main body unit 110 as shown in FIG. 3. The electrical conductor 304 is in communication with all of the cable receiving ports 170 through connection points 306 extending from each of the cable receiving ports 170. In an embodiment, the electrical conductor 304 is connected to each of the cable receiving ports 170 through the connection points 306 in a parallel circuitry configuration. The parallel circuitry configuration ensures a similar potential difference between the male plug portion 190 and each of the cable receiving ports 170 during operation of the connector plug assembly 100.

FIG. 4 illustrates the connector plug assembly 100 in operation. The connector plug assembly 100 is configured to be connected to an equipment 404 to receive an audio, video, electrical, electronic, or the like signals. In an embodiment, the connector plug assembly 100 is configured to be removably connected to a female jack portion 406 disposed on the equipment 404. As mentioned earlier and shown in FIG. 4, the connector plug assembly 100 is configured to receive multiple electrical wires 402 into the cable receiving ports 170. Although the accompanying figures illustrate six cable receiving ports 170, clamping member 302, and screw elements 185, the unitary main body unit 110 may additionally include more receiving ports, clamping member and screw elements without any limitation.

The multiple wires 402 as received into and secured in the cable receiving ports 170 through the clamping members 302 via fastening of the screw elements 185. Further as already mentioned that the connector plug assembly 100 is connected to the equipment 404 and is configured to receive any audio, video, electrical, electronic, or the like signals, and each of the cable receiving ports 170 are in parallel circuitry configuration with the male plug portion 190. Hence, potential difference associated with the any audio, video, electrical, electronic, or the like signals across the male plug portion 190 and each of the cable receiving ports 170 is same. Such an arrangement ensures an independent electrical connection for each of the multiple wires 402 secured in the cable receiving ports 170. The multiple wires 402 may have varying thickness, diameters and other dimensions, and may be appropriately accommodated within the unitary main body unit 110.

### INDUSTRIAL APPLICABILITY

The industrial applicability of the connector plug assembly 100 described herein will be readily appreciated from the foregoing discussion. As described earlier the connector plug assembly 100 includes the unitary main body unit 110 provided with the cable receiving ports 170 insulated from one another. Further, the multiple electrical wires 402 can be secured to the connector plug assembly 100 in the cable receiving ports 170. The multiple electrical wires 402 as provided to the connector assembly 100 are connected to the male portion 190 in a parallel circuitry configuration which ensures independent electrical connection for each of the multiple electrical wires 402, as the signal received from the equipment 404 is transmitted to each of the multiple electrical wires 402 through the male plug portion 190 at a similar potential difference.

The unitary main body unit 110 helps in avoiding stacking up of various banana plugs, as the multiple electrical wires 402 can be secured to the connector plug assembly 100 as an independent electrical connection. Such independent connection also ensures less distortion among the signals transmitted from the equipment 404 to the connector plug assembly 100 in comparison to prominence of such a scenario with stacking up of various banana plugs. The possibility of connecting the multiple electrical wires 402 to the connector plug assembly 100 also results in cost savings as stacking up of various banana plugs is avoided.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A multi-wire receiving electrical connector assembly, the multi-wire receiving electrical connector assembly comprising:
a unitary main body unit configured to receive the multiple electrical wires, the unitary main body unit including:
at least two cable receiving ports positioned in a side by side relationship with respect to each other, the at least two cable receiving ports provided on a first surface of the unitary main body unit, wherein each of the at least two cable receiving ports are partitioned from each other by a wall therebetween, each of the at least two cable receiving ports configured to receive one of the multiple electrical wires therein whereby independent electrical connection for each electrical wire is provided thereof;
at least two clamping members, each of the at least two clamping members associated with the respective cable receiving port, the at least two clamping members configured to attach the one of the multiple electrical wires within the respective cable receiving port; and
at least two screw elements positioned in a side by side relationship with respect to each other, the at least two screw elements provided on a second surface of the unitary main body unit, the second surface of the unitary main body unit being adjacent to the first surface, each of the at least two screw elements being in communication with the respective clamping member, each of the at least two screw elements configured to affix the one of the multiple electrical wires within the respective cable receiving port; and
a male plug portion extending from one end of the unitary main body unit, the male plug portion being electrically connected to each of the at least two cable receiving ports in a parallel configuration, wherein the male plug portion is configured to be removably connected to a female jack portion.

2. The multi-wire receiving electrical connector assembly of claim 1, wherein the cable receiving ports are six in number.

3. The multi-wire receiving electrical connector assembly of claim 1, wherein a sizing of each of the cable receiving ports are different from each other to accommodate multiple electrical wires having different diameters.

4. The multi-wire receiving electrical connector assembly of claim 1, wherein the first surface is a side surface of the unitary main body unit.

5. The multi-wire receiving electrical connector assembly of claim 1, wherein the second surface is a top surface of the unitary main body unit.

6. The multi-wire receiving electrical connector assembly of claim 1, wherein the at least two screw elements are configured to be tightened to securely hold each of the multiple electrical wires within the respective cable receiving port.

7. The multi-wire receiving electrical connector assembly of claim 1, wherein each of the cable receiving ports includes a connection point provided therein.

8. The multi-wire receiving electrical connector assembly of claim 7, wherein the connection point of each of the cable receiving ports is connected in a parallel circuitry with each other.
